(19) United States
(12) Patent Application Publication
(10) Pub. No.: US 2023/0134736 A1
(43) Pub. Date: May 4, 2023

(54) PET BREEDING TOOL

(71) Applicant: PixArt Imaging Inc., Hsin-Chu City (TW)

(72) Inventors: Chung-Ting Yang, Hsin-Chu City (TW); Kai-Ho Tsai, Hsin-Chu City (TW)

(73) Assignee: PixArt Imaging Inc., Hsin-Chu City (TW)

(21) Appl. No.: 17/519,536

(22) Filed: Nov. 4, 2021

(51) Int. Cl. A01K 1/03; A01K 5/02; G01P 3/36

(52) U.S. Cl. CPC A01K 1/031; A01K 5/02; G01P 3/36; G06F 3/147

(57) ABSTRACT

A pet breeding tool includes a roller, an optical sensor and an operation processor. The roller is adapted to rotate relative to an axle direction. The optical sensor is adapted to emit a detection beam toward the roller and receive a reflection beam from the roller. The operation processor is electrically connected to the optical sensor. The operation processor is adapted to analyze the reflection beam for acquiring rotation data of the roller, and further transform random variation of the rotation data into behavior of the roller for immediately adjusting output information relevant to the foresaid behavior.

### BACKGROUND OF THE INVENTION

### 1. Field of the Invention

The present invention relates to a pet breeding tool, and more particularly, to a pet breeding tool capable of utilizing a light bar disposed on a roller to provide a stable imaging function.

### 2. Description of the Prior Art

A pet breeding cage has limited inner space, and an animal cannot recklessly run inside the cage. A roller is disposed inside the pet breeding cage to be a toy for the animal. The conventional pet breeding cage disposes an illumination light bar on the roller, and the illumination light bar is illuminated when the roller is rotated to form a circular image due to visual persistence. The illumination light bar in the conventional pet breeding cage is illuminated in a constant scintillating frequency. A rotary speed of the roller is randomly changed due to behavior of the animal. If the conventional pet breeding cage intends to display a specific pattern via the illumination light bar illuminated in the constant scintillating frequency, the specific pattern within the circular image resulted from the illumination light bar may be deformed or faulted because of the randomly changed speed of the roller, which means the conventional pet breeding cage cannot display the stable image via the illumination light bar.

### SUMMARY OF THE INVENTION

The present invention provides a pet breeding tool capable of utilizing a light bar disposed on a roller to provide a stable imaging function for solving above drawbacks.

According to the claimed invention, a pet breeding tool includes a roller, an optical sensor and an operation processor. The roller is adapted to rotate relative to an axle direction. The optical sensor is adapted to emit a detection beam toward the roller and receive a reflection beam from the roller. The operation processor is electrically connected to the optical sensor. The operation processor is adapted to analyze the reflection beam for acquiring rotation data of the roller, and further transform random variation of the rotation data into behavior of the roller for immediately adjusting output information relevant to the foresaid behavior.

According to the claimed invention, the roller is disposed inside a cage. The cage includes a first pivoting portion, the roller comprises a second pivoting portion connected with the first pivoting portion in a rotatable manner, the axle direction is a structurally vertical direction of the second pivoting portion, and the optical sensor is disposed on the first pivoting portion and adapted to project the detection beam onto the second pivoting portion.

According to the claimed invention, the cage includes a fence and a base, the fence is fixed on the base to form a closed space whereinside the roller is disposed, the optical sensor is disposed on the fence or the base and adapted to project the detection beam onto an outer surface of the roller.

According to the claimed invention, the operation processor adjusts a specific parameter of the output information proportional to the random variation of the rotation data.

According to the claimed invention, the operation processor analyzes the random variation of the rotation data to acquire a number of circles and a rotary speed of the roller when being spun, so as to accordingly decide content of the output information. The operation processor acquire a moving distance, a moving period and a moving speed of a target object in accordance with the number of circles and the rotary speed in response to the target object moved inside a chamber of the roller.

According to the claimed invention, the pet breeding tool further includes an illumination light bar electrically connected to the operation processor. The operation processor is adapted to adjust a scintillating frequency of the illumination light bar in accordance with the random variation of the rotation data, so as to stably show the output information via the illumination light bar. The roller includes a roundel structure and an annular structure connected to each other, and a target object is able to move on the annular structure, and the illumination light bar is disposed on the roundel structure.

According to the claimed invention, the pet breeding tool further includes a display panel electrically connected to the operation processor. The operation processor is adapted to adjust a control parameter of the display panel in accordance with the random variation of the rotation data, so as to stably display the output information on the display panel.

According to the claimed invention, the pet breeding tool further includes a feeder electrically connected to the operation processor. The feeder has a valve and used to accommodate feed. The operation processor is adapted to lock or unlock the valve in accordance with accumulated variation of the rotation data. The operation processor analyzes the accumulated variation to compute calorie expenditure of a target object moved inside the roller.

According to the claimed invention, the pet breeding tool further includes an image identifier electrically connected to the operation processor. The operation processor is adapted to lock or unlock the valve in accordance with an identification result of the image identifier.

According to the claimed invention, the pet breeding tool further includes a signal transmitter electrically connected to the operation processor. The operation processor is adapted to transmit the output information toward an external device via the signal transmitter in a wire manner or in a wireless manner.

The pet breeding tool of the present invention can dispose the illumination light bar on the roller, and the illumination light bar can display the output information as the stable and complete image due to the visual persistence when the roller is rotated. The rotary speed of the roller is varied randomly in accordance with the behavior of the hamster; if the scintillating frequency of the illumination light bar is constant, the image formed by the illumination light bar may be deformed or faulted due to random change of the rotary speed of the roller. Therefore, the present invention can utilize the optical sensor to detect the number of circles and the rotary speed of the roller, and then immediately adjust the scintillating frequency of the illumination light bar in accordance with the known random variation of the rotation data of the roller, so that the performance image generated by the illumination light bar can be stable and not interfered by random rotation of the roller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an appearance diagram of a pet breeding apparatus according to an embodiment of the present invention.

FIG. 2 is a functional block diagram of the pet breeding apparatus according to the embodiment of the present invention.

FIG. 3 and FIG. 4 respectively are diagrams of the pet breeding apparatuses according to different embodiments of the present invention.

### DETAILED DESCRIPTION

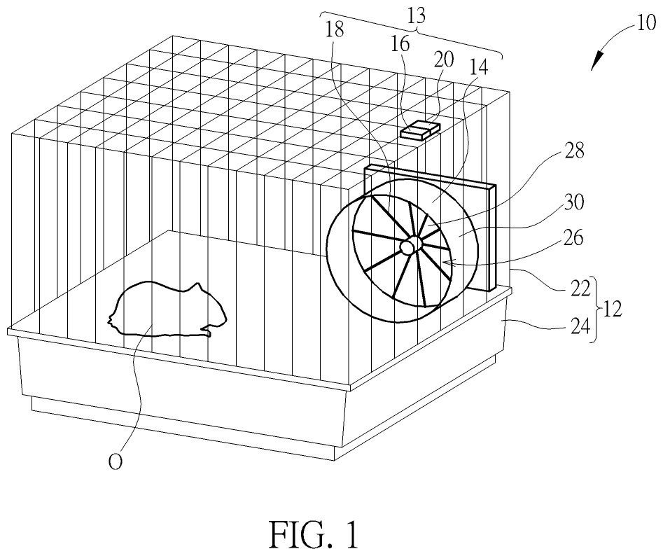

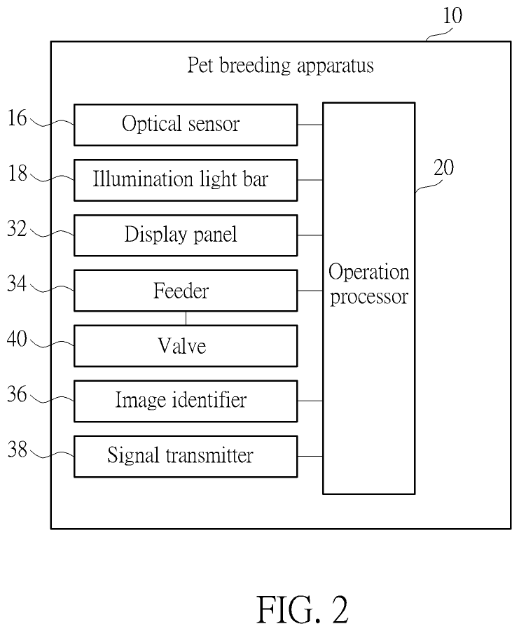

Please refer to FIG. 1 and FIG. 2. FIG. 1 is an appearance diagram of a pet breeding apparatus 10 according to an embodiment of the present invention. FIG. 2 is a functional block diagram of the pet breeding apparatus 10 according to the embodiment of the present invention. The pet breeding apparatus 10 can include a cage 12 and a pet breeding tool 13. A target object O lives in the cage 12. The pet breeding tool 13 is disposed inside the cage 12 to provide entertainment and survival supply. The pet breeding tool 13 can optionally include a roller 14, an optical sensor 16, an illumination light bar 18 and an operation processor 20. The cage 12 can have a fence 22 and a base 24. The base 24 can be an area whereinside the target object O stays and exercises, and the target object O can be a hamster or other animal.

The fence 22 can be fixed to sides of the base 24 to form a closed space for constraining the target object O. The roller 14 can be disposed inside the cage 12 in a rotatable manner. The roller 14 can have a chamber 26, and further have a roundel structure 28 and an annular structure 30 connected to each other. The chamber 26 can be an open space formed by the roundel structure 28 and the annular structure 30. The roundel structure 28 can be rotatably disposed on the fence 22. The target object O can run on the annular structure 30, and the annular structure 30 can be rotated relative to the cage 12 via the roundel structure 28.

The optical sensor 16 can be disposed on the fence 22, and may be above or near to a side the roller 14. The optical sensor 16 can project a detection beam onto an outer surface of the roller 14, and receive a reflection beam from the roller 14. The illumination light bar 18 can be disposed on the roundel structure 28 of the roller 14. The illumination light bar 18 can change its displaying content via adjustment of beam color and a scintillating frequency. The illumination light bar 18 can be a strip-type light bar. Two opposite ends of the strip-type light bar can respectively point toward an edge and a center of the roundel structure 28, which means if a supporting rib structure is connected between the roundel structure 28 and the annular structure 30, the illumination light bar 18 can be disposed on the said supporting rib structure. A number and distribution of the illumination light bar 18 is not limited to the embodiment shown in FIG. 1. When the roller 14 is rotated, a plurality of the illumination light bar 18 can provide a circular image due to visual persistence.

The operation processor 20 can be electrically connected to the optical sensor 16 and the illumination light bar 18. The operation processor 20 can analyze the reflection beam to acquire rotation data of the roller 14. For example, the annular structure 30 of the roller 14 can be a fencing structure, and the operation processor 20 can analyze an amplitude variation of the reflection beam during a unit period to compute a number of circles and a rotary speed of the roller 14; further, the annular structure 30 of the roller 14 may be an arc-surface structure, and the operation processor 20 can analyze a movement of an identification point formed on the arc-surface structure and detected by the reflection beam to compute the number of circles and the rotary speed of the roller 14. The rotation data of the roller 14 is not limited to the number of circles and the rotary speed, which depends on an actual demand, and computation of the rotation data is not limited to the above-mentioned embodiments.

When the rotation data of the roller 14 is acquired, the operation processor 20 can transform random variation of the rotation data into behavior of the roller 14, and immediately adjust output information relevant to the behavior of the roller 14. The output information can be displayed by the illumination light bar 18, or be performed or sent via any possible units or methods, which depends on a design demand. Generally, a running speed of the target object O inside the roller 14 is inconstant, so that the operation processor 20 can decide the behavior of the roller 14 belongs to uniform rotation, speed-up rotation or slow-down rotation via analysis of the rotation data of the roller 14. The illumination light bar 18 can display the output information due to the visual persistence resulted from rapid rotation, and therefore the operation processor 20 can maintain, increase or decrease the scintillating frequency of the illumination light bar 18 in accordance with the rotation data of the roller 14, so as to perform the output information via the stable circular image generated by the illumination light bar 18.

In the embodiment, if the roller 14 is rotated in a constant speed, the operation processor 20 can keep the illumination light bar 18 in a specific scintillating frequency; if the roller 14 is rotated in a speed-up mode, the operation processor 20 can increase the scintillating frequency of the illumination light bar 18; if the roller 14 is rotated in a slow-down mode, the operation processor 20 can decrease the scintillating frequency of the illumination light bar 18. The operation processor 20 can dynamically adjust the scintillating frequency of the illumination light bar 18 proportional to the random variation of the rotation data; however, the operation processor 20 may adjust the scintillating frequency of the illumination light bar 18 in accordance with the random variation of the rotation data in a non-linear manner. The operation processor 20 can further adjust information content or a specific parameter of the output information in accordance with the random variation of the rotation data, such as adjust a pattern, a color or a symbol within the circular image.

The pet breeding tool 13 can further include a display panel 32 electrically connected to the operation processor 20. The display panel 32 can be disposed outside the cage 12, such as being disposed above the fence 22 or on a side the fence 22. When the operation processor 20 analyzes the reflection beam of the optical sensor 16 and acquires the rotation data of the roller 14, the operation processor 20 can further adjust a control parameter of the display panel 32 in accordance with the random variation of the rotation data, so that the display panel 32 can stably display the output information. The illumination light bar 18 and the display panel 32 can be both used to display the output information, and may be disposed on the pet breeding apparatus 10 alternatively or simultaneously.

The pet breeding tool 13 can further include a feeder 34, an image identifier 36 and a signal transmitter 38 electrically connected to the operation processor 20. When the number of circles and the rotary speed of the roller 14 are acquired, the operation processor 20 can decide whether to open or close a valve 40 of the feeder 34 in accordance with accumulated variation of the rotation data. The valve 40 can be used to release or deposit feed inside the feeder 34. The accumulated variation of the rotation data can be interpreted as a moving distance, a moving period and a moving speed of the target object O. If at least one of the moving distance, the moving period and the moving speed exceeds a predefined threshold, the target object O is exercised adequately, and the operation processor 20 can open the valve 40 to release the feed from the feeder 34. If the moving distance, the moving period and/or the moving speed does not exceed the predefined threshold, the target object O has insufficient exercise, and the operation processor 20 can close the valve 40 to encourage the target object O to exercise for the feed.

In another possible embodiment, the operation processor 20 can further analyze the accumulated variation of the rotation data to compute calorie expenditure of the target object O when running inside the roller 14, and then display the related output information on the illumination light bar 18 and/or the display panel 32. The operation processor 20 can control an open angle and an open period of the valve 40 for adjusting a feeding amount of the feeder 34, so as to control health of the target object O.

If there has a plurality of target objects O existed inside the pet breeding apparatus 10, the image identifier 36 can identify body features of the plurality of target objects O via any available image identification skill, and decide to open or close the valve 40 of the feeder 34 in accordance with an identification result. For example, if one target object O just dined stays around the feeder 34, the operation processor 20 can close the valve 40; if the dined target object O leaves away and another hungry target object O approaches to the feeder 34, the operation processor 20 can open the valve 40 for releasing the feed.

The signal transmitter 38 can sent the output information to an external device in a wire manner or in a wireless manner. The external device may be a smart phone or any portable communication apparatus. If the user leaves home, the pet breeding apparatus 10 is generally stayed at home, and the operation processor 20 can sent the output information, which may represent and is displayed on the illumination light bar 18 and/or the display panel 32, synchronously toward the external device. The output information may be an accumulated moving distance, a length and distribution of the moving period, a fast moving speed, the calorie expenditure, and the feeding amount of the target object O, so that the user can be immediately aware of health condition of the pet.

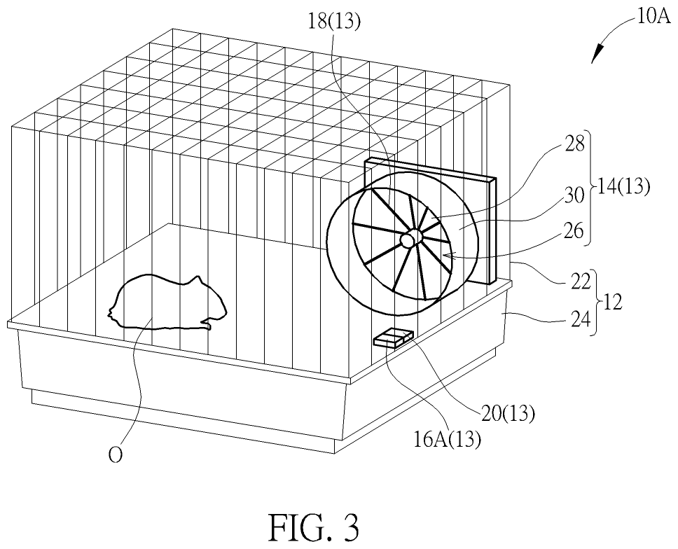

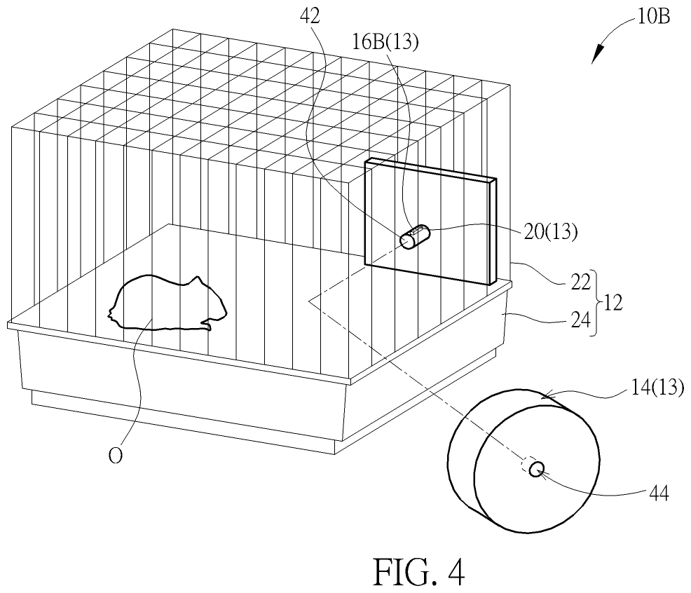

Please refer to FIG. 3 and FIG. 4. FIG. 3 and FIG. 4 respectively are diagrams of the pet breeding apparatuses 10A and 10B according to different embodiments of the present invention. As shown in FIG. 3, the optical sensor 16A of the pet breeding apparatus 10A can be optionally disposed on the base 24 of the cage 12, and preferably located under the roller 14. Functions of the optical sensor 16A are similar to functions of the optical sensor 16, and a detailed description is omitted herein for simplicity. As shown in FIG. 4, the cage 12 of the pet breeding apparatus 10B can have a first pivoting portion 42, and the roller 14 can have a second pivoting portion 44. The first pivoting portion 42 and the second pivoting portion 44 can respectively be a shaft and an axle hole, which depend on the design demand. The second pivoting portion 44 can be connected to the first pivoting portion 42 in a rotatable manner. The pet breeding apparatus 10B can dispose the optical sensor 16B on one of the first pivoting portion 42 and the second pivoting portion 44, and thus the optical sensor 16B can project the detection beam onto another pivoting portion to receive and analyze the reflection beam for acquiring the rotation data of the roller 14.

In conclusion, the pet breeding tool of the present invention can dispose the illumination light bar on the roller, and the illumination light bar can display the output information as the stable and complete image due to the visual persistence when the roller is rotated. The rotary speed of the roller is varied randomly in accordance with the behavior of the hamster; if the scintillating frequency of the illumination light bar is constant, the image formed by the illumination light bar may be deformed or faulted due to random change of the rotary speed of the roller. Therefore, the present invention can utilize the optical sensor to detect the number of circles and the rotary speed of the roller, and then immediately adjust the scintillating frequency of the illumination light bar in accordance with the known random variation of the rotation data of the roller, so that the performance image generated by the illumination light bar can be stable and not interfered by random rotation of the roller.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pet breeding tool, comprising:
a roller adapted to rotate relative to an axle direction;
an optical sensor adapted to emit a detection beam toward the roller and receive a reflection beam from the roller; and
an operation processor electrically connected to the optical sensor, the operation processor being adapted to analyze the reflection beam for acquiring rotation data of the roller, and further transform random variation of the rotation data into behavior of the roller for immediately adjusting output information relevant to the foresaid behavior.

2. The pet breeding tool of claim 1, wherein the roller is disposed inside a cage, the cage comprises a first pivoting portion, the roller comprises a second pivoting portion connected with the first pivoting portion in a rotatable manner, the axle direction is a structurally vertical direction of the second pivoting portion, the optical sensor is disposed on the first pivoting portion and adapted to project the detection beam onto the second pivoting portion.

3. The pet breeding tool of claim 2, wherein the cage comprises a fence and a base, the fence is fixed on the base to form a closed space whereinside the roller is disposed, the optical sensor is disposed on the fence or the base and adapted to project the detection beam onto an outer surface of the roller.

4. The pet breeding tool of claim 1, wherein the operation processor adjusts a specific parameter of the output information proportional to the random variation of the rotation data.

5. The pet breeding tool of claim 1, wherein the operation processor analyzes the random variation of the rotation data to acquire a number of circles and a rotary speed of the roller when being spun, so as to accordingly decide content of the output information.

6. The pet breeding tool of claim 5, wherein the operation processor acquire a moving distance, a moving period and a moving speed of a target object in accordance with the number of circles and the rotary speed in response to the target object moved inside a chamber of the roller.

7. The pet breeding tool of claim 1, further comprising:
an illumination light bar electrically connected to the operation processor, the operation processor being adapted to adjust a scintillating frequency of the illumination light bar in accordance with the random variation of the rotation data, so as to stably show the output information via the illumination light bar.

8. The pet breeding tool of claim 7, wherein the roller comprises a roundel structure and an annular structure connected to each other, a target object is able to move on the annular structure, and the illumination light bar is disposed on the roundel structure.

9. The pet breeding tool of claim 1, further comprising:
a display panel electrically connected to the operation processor, the operation processor being adapted to adjust a control parameter of the display panel in accordance with the random variation of the rotation data, so as to stably display the output information on the display panel.

10. The pet breeding tool of claim 1, further comprising:
a feeder electrically connected to the operation processor, the feeder having a valve and used to accommodate feed, the operation processor being adapted to lock or unlock the valve in accordance with accumulated variation of the rotation data.

11. The pet breeding tool of claim 10, wherein the operation processor analyzes the accumulated variation to compute calorie expenditure of a target object moved inside the roller.

12. The pet breeding tool of claim 10, further comprising:
an image identifier electrically connected to the operation processor, the operation processor being adapted to lock or unlock the valve in accordance with an identification result of the image identifier.

13. The pet breeding tool of claim 1, further comprising:
a signal transmitter electrically connected to the operation processor, the operation processor being adapted to transmit the output information toward an external device via the signal transmitter in a wire manner or in a wireless manner.
